(19) United States
(12) Patent Application Publication
(10) Pub. No.: US 2008/0169614 A1
(43) Pub. Date: Jul. 17, 2008

(54) Compliant plate seal assembly apparatus and assembly method thereof

(76) Inventors: Shorya Awtar, Ann Arbor, MI (US); Norman Arnold Turnquist, Sloansville, NY (US); Jason Paul Mortzheim, Gloversville, NY (US)

Correspondence Address: CANTOR COLBURN, LLP, 20 Church Street, 22nd Floor, Hartford, CT, 06103, US

(21) Appl. No.: 11/652,752

(22) Filed: Jan. 12, 2007

(51) Int. Cl. F16J 15/00

(52) U.S. Cl. 277/592

(57) ABSTRACT

A shaft seal assembly between a rotating shaft and a static shell is disclosed. The shaft seal assembly includes a seal housing in mechanical contact with the static shell, at least two rigid members of the seal housing, and a plurality of compliant plate members defining a sealing ring between the static shell and the rotating shaft. The plurality of compliant plate members is disposed between the at least two rigid members and retained within the seal housing by a compressive force between the at least two rigid members.

### BACKGROUND OF THE INVENTION

The present disclosure relates to sealing structures between a rotating component and a static component typically found in turbomachinery and, more particularly, to a compliant-plate seal arrangement.

Dynamic sealing between a rotor (such as rotating shaft) and a stator (such as a static shell, casing, or housing) is an important concern in turbomachinery. Several methods of sealing have been proposed in the past. In particular, sealing based on flexible members has been utilized including seals described as leaf seals, brush seals, finger seals, shim seals, and shingle seals, for example.

A brush seal comprises tightly packed generally cylindrical bristles that are effective in preventing leakage because of their staggered arrangement. The bristles have a low radial stiffness that allows them to move out of the way in the event of a rotor excursion while maintaining a tight clearance during steady state operation. Brush seals, however, are effective only up to a certain pressure differential across the seal. Because of the generally cylindrical geometry of the bristles, the brush seals tend to have a low stiffness in the axial direction, which limits the maximum operable pressure differential to generally less than 1000 pounds per square inch (psi). Radial and axial directions in this context are defined with respect to the turbo-machine axis.

To overcome this problem, compliant plate members that include a plate-like geometry have been proposed for use in a shaft seal assembly, which includes a seal housing disposed in contact with the stator. The proposed compliant plates provide higher axial stiffness and therefore the capability of handling larger pressure differentials than brush seals. Current attachment methods of these compliant plates to the seal housing include processes such as welding and brazing. These processes introduce large amounts of heat into the seal assembly in order to adequately attach the plates to the seal housing, and therefore require the use of metallic compliant plates. The heat can cause distortion of the seal housing and the compliant plates, material property deterioration, and diffusion bonding between the compliant plates, which can reduce the effectiveness of the shaft seal assembly. Attempts to reduce effects of the heat during brazing or welding include the use of high temperature materials that increase the cost of the sealing arrangement.

Accordingly, there is a need in the art for an attachment arrangement that overcomes these drawbacks.

### BRIEF DESCRIPTION OF THE INVENTION

An embodiment of the invention includes a shaft seal assembly between a rotating shaft and a static shell. The shaft seal assembly includes a seal housing in mechanical contact with the static shell, at least two rigid members of the seal housing, and a plurality of compliant plate members defining a sealing ring between the static shell and the rotating shaft. The plurality of compliant plate members is disposed between the at least two rigid members and retained within the seal housing by a compressive force between the at least two rigid members.

Another embodiment of the invention includes a method of assembling a shaft seal assembly, for disposal between a rotating shaft and a static shell. The method includes disposing a plurality of compliant plate members between at least two rigid members, the plurality of compliant plate members defining a sealing ring between the static shell and the rotating shaft, applying a compressive force between the at least two rigid members to the plurality of compliant plate members; and retaining the location of the plurality of compliant plate members between the at least two rigid members.

### BRIEF DESCRIPTION OF THE DRAWINGS

Referring to the exemplary drawings wherein like elements are numbered alike in the accompanying Figures:

FIG. 1 depicts a perspective view of a shaft seal assembly in accordance with an embodiment of the invention;

FIG. 2 depicts a circumferential section view of a shaft seal assembly in accordance with an embodiment of the invention;

FIG. 3 depicts an axial end view of a shaft seal assembly in accordance with an embodiment of the invention;

FIG. 4 depicts a circumferential section view of the shaft seal assembly depicted in FIG. 3 in accordance with an embodiment of the invention;

FIG. 5 depicts an axial end view of a shaft seal assembly in accordance with an embodiment of the invention;

FIG. 6 depicts a circumferential section view of the shaft seal assembly depicted in FIG. 5 in accordance with an embodiment of the invention;

FIG. 7 depicts an enlarged view of an orientation of a compliant plate member of the shaft seal assembly depicted in FIG. 5 in accordance with an embodiment of the invention;

FIG. 8 depicts an end view of a diameter adjustment mechanism in accordance with an embodiment of the invention;

FIG. 9 depicts side views of compliant plate members in accordance with embodiments of the invention;

FIG. 10 depicts side views of compliant plate members in accordance with embodiments of the invention;

FIG. 11 depicts a circumferential section view of a shaft seal assembly in accordance with an embodiment of the invention;

FIG. 12 depicts a schematic circumferential section view of a shaft seal assembly in accordance with an embodiment of the invention;

FIG. 13 depicts an internal section view of a housing of the shaft seal assembly depicted in FIG. 12 in accordance with an embodiment of the invention;

FIG. 14 depicts an axial end view of two housings of the shaft seal assembly depicted in FIG. 12 in accordance with an embodiment of the invention;

FIG. 15 depicts a circumferential end view of a housing of the shaft seal assembly depicted in FIG. 12 in accordance with an embodiment of the invention;

FIG. 16 depicts a circumferential section view of a shaft seal assembly in accordance with an embodiment of the invention;

FIG. 17 depicts a circumferential section view of a shaft seal assembly in accordance with an embodiment of the invention; and

FIG. 18 depicts a flowchart of a method of assembly of a shaft seal assembly in accordance with an embodiment of the invention.

### DETAILED DESCRIPTION OF THE INVENTION

An embodiment of the invention provides compliant plate seal assemblies using mechanical clamping devices to attach the compliant plates to the seal housing with minimal or no welding or brazing, thereby avoiding the negative effects resulting from exposure to high temperatures. In an embodiment, the compliant plate seal assemblies will accommodate the use of non-metallic plate components. Reducing exposure to the high temperatures associated with welding and brazing is further contemplated to reduce the manufacturing cost of seal assemblies.

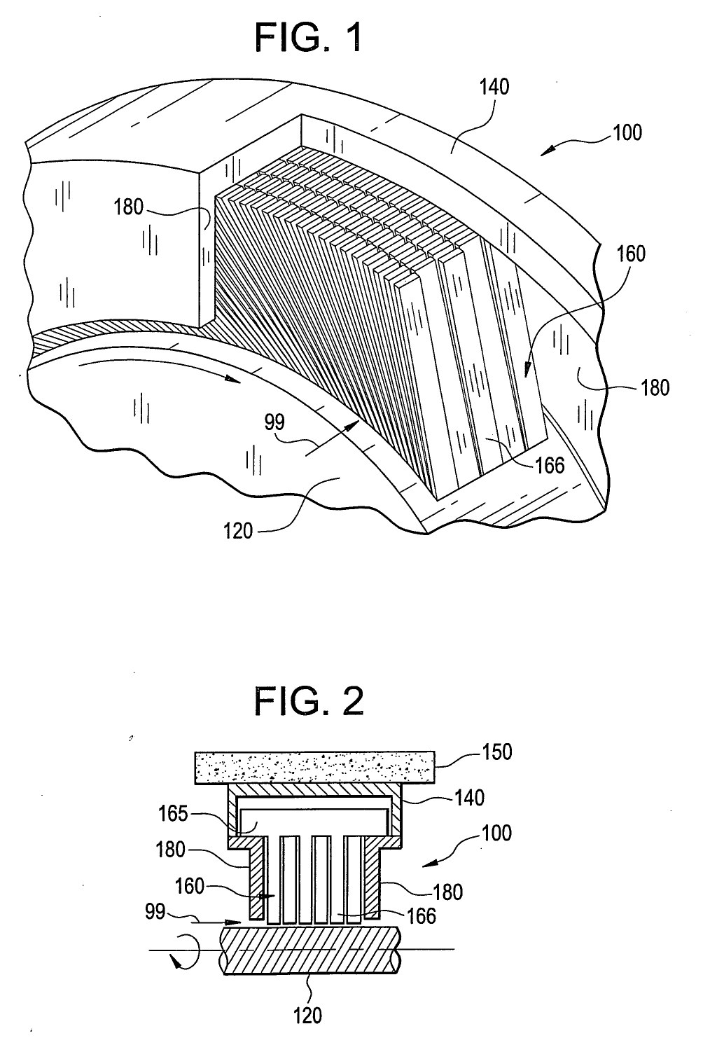

Referring now to FIGS. 1 and 2, a shaft seal assembly 100 serves to reduce primary axial leakage between a rotor 120, such as a rotating shaft, and the static seal housing 140, also herein referred to as a housing, attached to, or in mechanical contact with the turbine static shell 150, also herein referred to as a stator. It will be appreciated that the axial leakage is the result of a pressure differential that exists relative to the sides of the seal assembly 100, such as indicated by an axial direction line 99. The shaft seal assembly 100 is provided with a plurality of compliant plate members 160, also herein referred to as plates, arranged face-to-face circumferentially around the rotor 120, and secured at their roots 165 to the housing 140. In an embodiment, the compliant plate members 160 have a T-shape as shown in FIG. 2 for installation purposes. Tips 166 of the compliant plate members 160 provide a primary seal between the housing 140 and the rotating shaft 120 to prevent axial 99 flow between the plates 160 and the rotor 120. In an embodiment, static non-compliant annular rings 180, attached to the housing 140, provide an initial resistance to leakage flow, and also serve to contain and protect the plates 160. The compliant plate members 160 provide radial compliance or bending flexibility and axial stiffness, which are important for the functionality of the seal assembly 100.

An important advantage of compliant plate seals 160 is a pressure build-up effect that is generated upon rotor 120 rotation. The effect causes the tips 166 of the plates 160 to lift during rotation of the rotor 120. In response to this lift, any other pressure forces, and compliant plate material elasticity, an equilibrium state is attained for each plate 160 that leaves a very small clearance between the tips 166 of plates 160 and the rotor 120. This small clearance between the plate tips 166 and the rotor 120 reduces frictional heat generation by minimizing or eliminating physical contact.

An embodiment of a mechanical seal assembly will include at least two rigid members of the housing 140 and the plurality of compliant plate members 160 defining a sealing ring between the stator 150 and the rotor 120. The plurality of compliant plate members 160 are disposed between the at least two rigid members, and are retained within the housing 140 by a compressive force between the at least two rigid members.

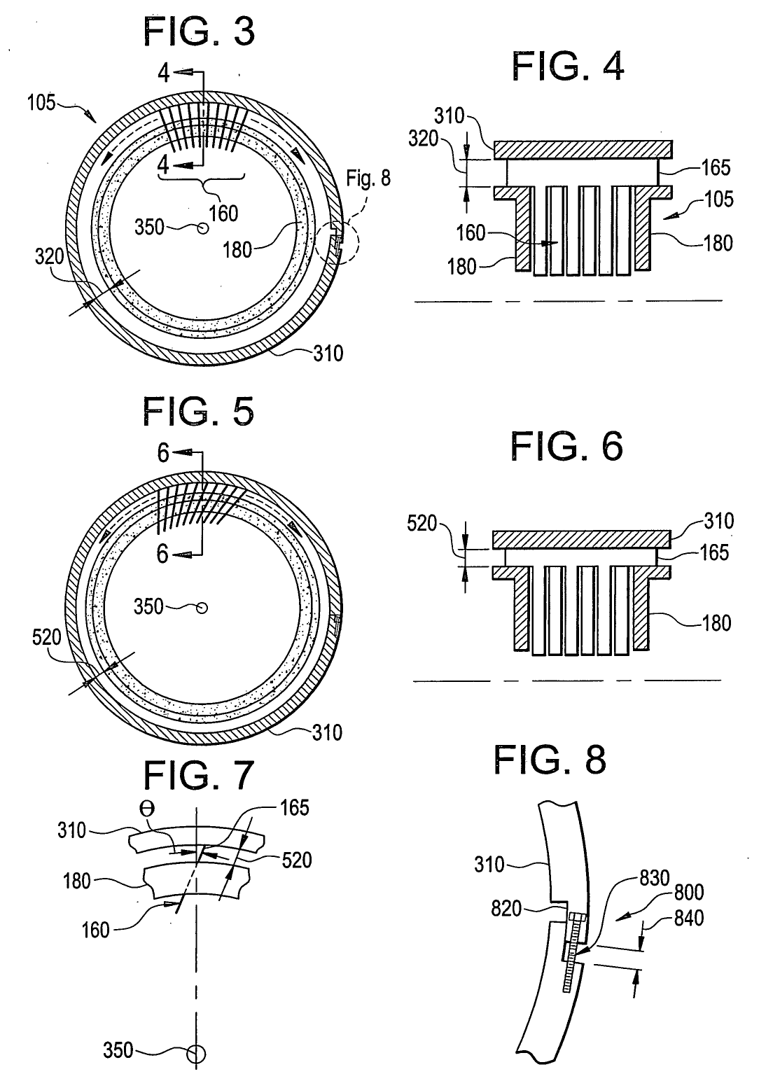

Referring now to FIG. 3, an axial end view of an embodiment of a mechanical seal assembly 105 is depicted. The mechanical seal assembly 105 provides for retention of the compliant plate members 160 by the rings 180 and an adjustable diameter outer housing 310, also herein referred to as an outer band, without welding or brazing. Although the seal assembly 105 in FIG. 3 depicts only a portion of the plurality of compliant plate members 160 for clarity of illustration, it will be appreciated that a full circumference of compliant plate members 160 will be disposed around the rings 180 in facing relation. With reference to FIG. 4 in conjunction with FIG. 3, the T-shaped plates 160 will be located by the rigid members, which include the annular rings 180 and the adjustable diameter outer housing 310. An initial gap 320 is equal to a radial height of the root 165 of the compliant plate member 160. Because the gap 320 is equal to the radial height of the root 165 of the compliant plate member 160, each compliant plate member 160 will have a radial orientation, such that it is oriented toward a center 350 of the annular rings 180 and rotor 120 (not shown in FIG. 3).

Referring now to FIGS. 5 and 6, an axial end view and radial section view of the mechanical seal assembly 105 in response to a reduction of the diameter of the outer band 310 is depicted. It will be appreciated that a gap 520 is smaller than the gap 320 depicted in FIGS. 3 and 4. Therefore, the gap 520 is less than the radial height of the root 165 of the compliant plate member 160, thereby applying a radial compressive force upon the roots 165, to retain and orient the plurality of compliant plate members 160 between the outer band 310 and the rings 180. Upon such assembly, each compliant plate member 160 of the plurality of compliant plate members 160 will have a canted orientation relative to the center 350 of the annular rings 180 and rotor 120 as depicted in FIG. 5.

While an embodiment of the mechanical seal assembly has been described having an adjustable outer band 310, it will be appreciated that the scope of the embodiment is not so limited, and that the embodiment will also apply to mechanical seal assemblies that may have a fixed diameter outer band to provide the appropriate gap height, for example.

Referring now to FIG. 7, an enlarged view of single compliant plate member 160 including the canted orientation, as shown in FIG. 5, is depicted. A cant angle θ of the plurality of compliant plate members 160 is defined by the gap 520 between the outer band 310 and the rings 180. The cant angle θ defines an amount of change in tangential orientation, relative to the radial orientation. It will be appreciated that in response to the gap 520 being less than the radial height of the root 165 of the compliant plate member 160, the radial height of the root 165 of each compliant plate member 160 will form a hypotenuse of a right triangle that includes the gap 520 and the cant angle θ. Therefore, a desired cant angle θ can be provided by proper adjustment of the gap 520 height.

Referring now to FIG. 8, an exemplary embodiment of a diameter adjustment mechanism 800 is depicted. In an embodiment, the diameter adjustment mechanism 800 includes a one piece outer band 310 that includes a split 820 and a fastener 830, such as a bolt, to adjust a gap 840 in the outer band 310. It will be appreciated that the diameter of the outer band 310, the height of the gap 520, and therefore the cant angle θ, will change in response to adjustments in the gap 840 of the adjustable gap mechanism 800.

While an embodiment has been described having a diameter adjustment mechanism including a fastener such as a bolt, it will be appreciated that the scope of the embodiment is not so limited, and that the embodiment will also apply to other diameter adjustment mechanisms, such as lever/toggle closure mechanisms, engaging ratchet teeth, and pneumatic cylinder activation, to provide a change in the diameter of the outer band 310 for example.

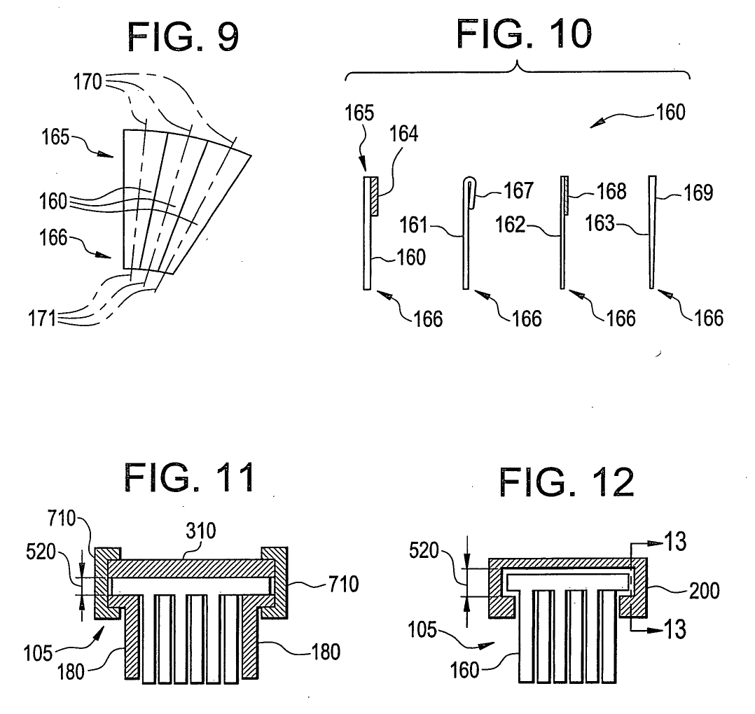

Referring now to FIGS. 9 and 10, side views of alternate embodiments of compliant plate members 160 are depicted. It will be appreciated that increasing the thickness of the root 165 will allow for a tight circumferential packing together of the roots 165. Accordingly, a distance between a center 170 of each plate 160 of each pair of adjacent compliant plate members 160 of the plurality of compliant plate members 160 is greater at the root 165 end proximate to the stator 150 than the distance between a center 171 of each plate 160 of each pair of adjacent compliant plate members at the tip end 166 proximate to the rotating shaft 120. A tight circumferential packing together of the roots 165 will reduce the potential of buckling of the roots 165 in response to the radial compressive force, such as the radial compressive force resulting from the gap 520 being smaller than the radial height of the root 165. Furthermore, the tight circumferential packing of the roots 165 will reduce the potential of buckling of the roots 165 in response to an axial compressive force, as will be described further below. The thicker root 165 can also provide for a defined amount of clearance between the tips 166 to prevent binding between the plates 160, and thereby provide for the desired radial compliance, as will be appreciated by one skilled in the art. Accordingly, it is desired to have compliant plate members 160 that have a thicker cross section at the root 165 than at the tip 166.

In an embodiment, the distance between the center 170 of each compliant plate 160 of each pair of adjacent compliant plate members 160 at the root 165 end is defined by at least one of a compliant plate member 161 including a folded root 167, which effectively doubles the thickness of the root 167, a compliant plate member 162 including a coated, or plated root 168 to increase the thickness of the root 168, a tapered compliant plate member 163 with a thickness greater at the root 169 than the tip 166, and a shim 164 disposed between the plates 160 at the root 165 ends to provide adequate buckling resistance and proper clearance between the tips 166.

Referring now to FIG. 11, an embodiment of the mechanical seal assembly 105 is depicted that includes a set of clamping rings 710. The clamping rings 710 hold the mechanical seal assembly 105 together, and ensure that the gap 520 between the rings 180 and the outer band 310 remains fixed. Further, the clamping rings 710 can reduce secondary leakage, which is defined as any leakage flow other than the primary axial leakage. In an embodiment, the clamping rings 710 are attached to the rings 180 and the outer band 310 via mechanical crimping. In another embodiment, the clamping rings 710 are attached to the rings 180 and the outer band 310 via welding. It will be appreciated that welding of the clamping rings 710 to the rings 180 and the outer band 310 introduces less heat than welding or brazing the compliant plate members 160 to the housing 140, and will therefore not result in distortion of the plates 160 or the rings 180.

Referring now to FIG. 12 and FIG. 13, an alternate embodiment of the mechanical seal assembly 105 is depicted. A housing 200 includes a geometry that is the same as, or complementary to a geometry of the plurality of plates 160 in order to provide axial and radial retention of the plates 160. In an embodiment, the housing 200 and the plates 160 will include the T-shaped geometry. In an embodiment, the housing 200 includes the appropriate gap 520 corresponding to the desired cant angle θ of the plates 160, as described above. FIG. 13 depicts an interior section view of the housing 200. The housing 200 is an arc segment, or arcuate housing 200, rather than a full circumferential annular ring. The arcuate housing 200 depicted in FIG. 13 is an arc segment of K degrees. It will therefore be appreciated that the full mechanical seal assembly 105 will utilize more than one arcuate housing 200, or 360/K arcuate housings 200. The arcuate housing 200 includes a first end 201 and a second end 202. The at least two rigid members include endplates 210 disposed at the first end 201 and the second end 202 to circumferentially retain and orient the plates 160 within the housing 200. The first end 201 is oriented at a first angle θ1 relative to a center 203 of the arcuate housing 200. By stacking the plurality of compliant plate members 160 against the endplates 210, the cant angle θ of the plurality of compliant plate members 160 will thereby be defined by the first angle θ1 of the first end 201 of the housing 200. The second end 202 is oriented at a second angle θ2 relative to the center 203 of the arcuate housing 200. In an embodiment, the cant angle θ of the plurality of compliant plate members 160 will thereby be defined by the second angle θ2 of the second end 202 of the housing 200. In an exemplary embodiment, the second angle θ2 is approximately equal to the first angle θ. As used herein, the term “approximately equal” shall refer to a minimum deviation resulting from manufacturing, design and assembly tolerances such that appropriate guidance and retention is provided to the plurality of compliant plate members 160.

One of the two endplates 210 shall be fastened to the housing 200 prior to the insertion of the plates 160, and the other endplate 210, shall be fastened to the housing 200 subsequent to the insertion of the plates 160. The endplates will apply a circumferential compressive force to retain and orient the plurality of compliant plate members 160 within the arcuate housing 200. The endplates 210 shall be affixed to the housing 200 via an appropriate fastening technique, such as to use threaded fasteners, rivets, or welding, for example. It will be appreciated that use of welding to affix the endplates 210 to the housing 200 will introduce less heat than welding or brazing the plates 160 to the housing 200, and will therefore not result in distortion of the housing 200 or the plates 160.

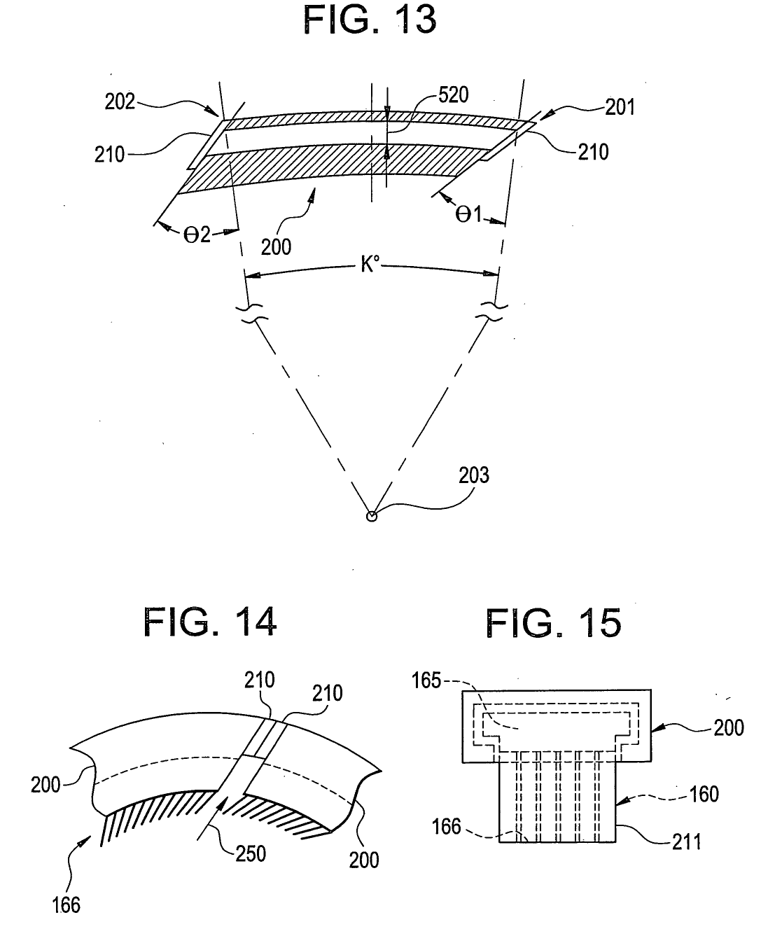

Referring now to FIG. 14, it will be appreciated that the end plate 210 shown in FIG. 13 will create a gap 250 between two adjoining segments of the housing 200. This gap 250 may contribute to additional primary axial leakage. Referring now to FIG. 15, an embodiment of the housing 200 including a full length end plate 211 that includes geometry corresponding, or similar to the plate 160, but formed to match an exterior geometry of the housing 200 is depicted. The full length endplate 211 will therefore eliminate the gap 250 between any two adjoining housing 200 segments. In an embodiment, the full length endplate 211 includes at least one plate 160 having an appropriately enlarged geometry proximate the root 165 portion of the plate 160 to restrain the other plates 160 within the housing 200, and a geometry of the full length endplate 211 matching geometry at the tip 166 end of the plates 160 to eliminate the gap 250 between the arcuate housings 200.

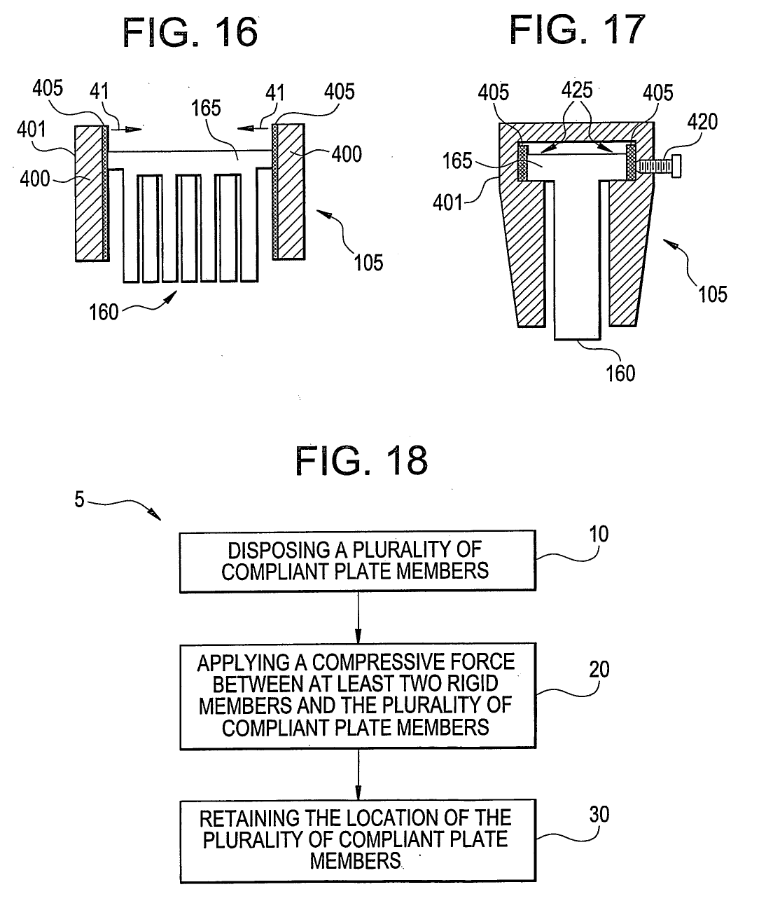

Referring now to FIG. 16, an embodiment of the mechanical seal assembly 105 in which the at least two rigid members include rings 400 is depicted. Once the compliant plates 160 are assembled circumferentially in facing relation, the rings 400 apply an axial compressive force, as indicated by direction lines 41, and thereby provide a seal housing 401. The compressive axial force thereby clamps the roots 165 to retain the position of the plates 160. An embodiment will include deformable interface surfaces 405 in contact with the plurality of compliant plate members 160. The interface surfaces 405 deform such that variation of the width of the roots 165 can be accommodated. It will be appreciated that in the absence of the interface surfaces 405, the plates 400 would make proper contact with only the roots 165 having the greatest axial width, or that, in response to applying enough axial force to cause the plates 400 to contact the narrowest of roots 165, the widest roots 165 may be caused to buckle. In an embodiment, the interface surfaces 405 within the seal housing 410 are attached to the plates 400, as depicted in FIG. 16. In another embodiment, the interface surfaces 405 are provided by a coating applied to the rigid plates 400. In another embodiment, the plates 400 are fabricated from the material that is capable of deformation in response to varying root length. In another embodiment, the deformable material is incorporated onto the roots 165 of the plates 160.

Referring now to FIG. 17, another embodiment of the mechanical seal assembly 105 is depicted. The axial force to clamp the roots 165 between the interface surfaces 405 within the seal housing 401 is provided by a fastener 420, such as a set-screw. The mechanical seal assembly 105 includes recesses 425 to match the geometry of the plates 160, thereby providing radial retention of the plates 160. Tightening the fastener against interface surfaces or components 405 applies the axial compressive force to retain the plates 160.

Accordingly, assembly of the mechanical seal assembly will be discussed with reference to FIGS. 2,3, 5, 11, 12, and 15. A generalized flowchart 5 of process steps for assembling a complaint plate seal assembly, such as the compliant plate seal assembly 105, is depicted in FIG. 17.

The method begins by disposing at Step 10 the plurality of compliant plate members 160 between at least two rigid members, the plurality of compliant plate members 160 defining a sealing ring between the stator 150 and the rotating shaft 120. The method continues with applying at Step 20 a compressive force between the at least two rigid members to the plurality of compliant plate members 160, and in response to the applying the compressive force, retaining at Step 30 the location of the plurality of compliant plate members 160 between the at least two rigid members.

In an embodiment of the method, the applying at Step 20 includes applying the radial compressive force between the outer band 310 and at least one of the annular rings 180. The method further includes defining the cant angle θ of the plurality of compliant plate members 160 in response to the gap 520 between the outer band 310 and the annular rings 180.

An embodiment of the method further includes fastening one of the at least two rigid members 210 to the first end 201 of the arcuate housing 200 comprising geometry complementary to geometry of the plurality of compliant plate members 160, and disposing the plurality of compliant plate members 160 within the arcuate housing 200. In an embodiment, the disposing occurs subsequent to the fastening one of the rigid members 210. The method further includes attaching the second of the at least two rigid members 210 to the second end 202 of the arcuate housing 200. It will be appreciated that a number of the compliant plate members 160 disposed within the arcuate housing 200 between the first end 201 and the second end 202 will be large enough that the application and fastening of the two rigid plates 210 will compress the compliant plate members 160 at the root 165 end. Accordingly, in response to the fastening, disposing, and attaching, the applying at Step 20 the compressive force is the circumferential compressive force between the at least two rigid members 210 to the plurality of compliant plate members 160. In an embodiment, the fastening includes defining a cant angle of the plurality of compliant plate members 160 by the angle of the first end 201 of the arcuate housing 200.

In an embodiment, the applying at Step 20 includes applying an axial compressive force to the plurality of compliant plate members via the deformable interface surface 405.

As disclosed, some embodiments of the invention may include some of the following advantages: the ability to utilize non-metallic compliant plate members; the ability to minimize or eliminate brazing and welding the compliant plate members; and the ability to reduce assembly cost.

While embodiments of the invention have been depicted including annular rings 180 and housings 401 that extend substantially toward the tips 166 of the compliant plate members 160, such as in FIGS. 2, 4, 6, 11, 16, and 17, it will be appreciated that the scope of the invention is not so limited, and that the invention will also apply to shaft seal assemblies 105 that utilize annular rings 180 and housings 401 that do not extend substantially toward the tips 166 of the compliant plate members, such as the housing 200 depicted in FIGS. 12 and 15, for example.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A shaft seal assembly between a rotating shaft and a static shell, the shaft seal assembly comprising:
a seal housing in mechanical contact with the static shell;
at least two rigid members of the seal housing; and
a plurality of compliant plate members defining a sealing ring between the static shell and the rotating shaft, the plurality of compliant plate members disposed between the at least two rigid members and retained within the seal housing by a compressive force between the at least two rigid members.

2. The shaft seal assembly of claim 1, wherein:
a distance between a center of each compliant plate member of each pair of adjacent compliant plate members of the plurality of compliant plate members is greater at a root end proximate the static shell than a tip end proximate the rotating shaft.

3. The shaft seal assembly of claim 2, wherein the distance between the center of each compliant plate of each pair of adjacent compliant plate members at the root end is defined by at least one of:
a compliant plate member comprising a folded root end;
a compliant plate member comprising a plated root end;
a tapered compliant plate member having a thickness greater at the root end; and
a shim disposed between root ends of adjacent compliant plate members.

4. The shaft seal assembly of claim 1, wherein:
the plurality of compliant plate members comprise non-metallic compliant plate members.

5. The shaft seal assembly of claim 1, wherein:
the plurality of compliant plate members comprise metallic compliant plate members.

6. The shaft seal assembly of claim 1, wherein:
the compressive force comprises a radial compressive force.

7. The shaft seal assembly of claim 6, wherein:
at least one of the at least two rigid members comprises an outer band; and
the other of the at least two rigid members comprise an annular ring.

8. The shaft seal assembly of claim 7, wherein:
a cant angle of the plurality of compliant plate members is defined by a gap between the outer band and the annular ring.

9. The shaft seal assembly of claim 1, wherein:
the compressive force comprises a circumferential compressive force; and
the shaft seal assembly further comprises more than one arcuate housing comprising a first end and a second end, each arcuate housing comprising geometry complementary to geometry of the plurality of compliant plate members.

10. The shaft seal assembly of claim 9, wherein:
the first end is oriented at a first angle relative to a center of the arcuate housing;
the second end is oriented at a second angle relative to the center of the arcuate housing; and
the first angle is approximately equal to the second angle.

11. The shaft seal assembly of claim 9, wherein:
a cant angle of the plurality of compliant plate members is defined by at least one of an angle of the first end of the arcuate housing and an angle of the second end of the arcuate housing.

12. The shaft seal assembly of claim 11, wherein:
at least one of the at least two rigid members comprises geometry corresponding to the plurality of compliant plate members.

13. The shaft seal assembly of claim 9, wherein:
the at least two rigid members of the seal housing are disposed at the first end and the second end of each of the more than one arcuate housing.

14. The shaft seal assembly of claim 1, wherein:
the compressive force comprises an axial compressive force.

15. The shaft seal assembly of claim 14, further comprising:
a deformable interface surface in contact with the plurality of compliant plate members at the roots.

16. A method of assembling a shaft seal assembly, for disposal between a rotating shaft and a static shell, the method comprising:
disposing a plurality of compliant plate members between at least two rigid members, the plurality of compliant plate members defining a sealing ring between the static shell and the rotating shaft;
applying a compressive force between the at least two rigid members to the plurality of compliant plate members; and
retaining the location of the plurality of compliant plate members between the at least two rigid members.

17. The method of claim 15, wherein the disposing comprises:
disposing the plurality of complaint plate members, at least one compliant plate member of the plurality of compliant plate members comprising at least one of:
a folded root end;
a plated root end;
a taper comprising a thickness greater at a root end; and
a shim disposed between adjacent root ends of adjacent compliant plate members.

18. The method of claim 16, wherein the applying the compressive force comprises:
applying a radial compressive force.

19. The method of claim 18, wherein:
the applying is between an outer band and at least one annular ring.

20. The method of claim 19, further comprising:
defining a cant angle of the plurality of compliant plate members in response to a gap between the outer housing and the at least one annular ring.

21. The shaft seal assembly of claim 1, wherein the plurality of compliant plate members are disposed between the at least two rigid members and retained within the seal housing absent welding of the plurality of compliant plate members.

22. The method of claim 16, wherein the retaining is absent welding of the compliant plate members.
